(19) United States
(12) Patent Application Publication
(10) Pub. No.: US 2025/0383285 A1
(43) Pub. Date: Dec. 18, 2025

(54) INSPECTION APPARATUS AND METHOD OF CONTROLLING INSPECTION APPARATUS

(71) Applicant: CANON KABUSHIKI KAISHA, Tokyo (JP)

(72) Inventor: TOSHIYUKI SANO, Tokyo (JP)

(21) Appl. No.: 19/229,768

(22) Filed: Jun. 5, 2025

(30) Foreign Application Priority Data
Jun. 13, 2024 (JP) 2024-096266

(51) Int. Cl. G01N 21/57; G01N 21/88

(52) U.S. Cl. CPC G01N 21/57; G01N 21/8806; G01N 21/8851; G01N 2201/061

(57) ABSTRACT

An inspection apparatus comprises a plurality of light sources configured to emit light to an inspection region, an image capturing apparatus configured to capture an image of the inspection region irradiated with light from at least some of the plurality of light sources, at least one memory, and at least one processor. The at least one memory and the at least one processor are configured to perform inspection related to the inspection region based on a captured image obtained by the capturing. The plurality of light sources are arranged at positions where virtual images corresponding to the light sources surround the inspection region.

### BACKGROUND

### Field of the Disclosure

The present disclosure relates to an inspection technique.

### Description of the Related Art

A known method for appearance inspection of industrial products includes detecting a defect on a product surface by means of multi-lamp illumination. The gloss unevenness, which is a difference in gloss intensity among regions, is characterized in that it is not easily detected when specular reflected light is directly received, and is easily detected when a reflection component in the vicinity of the specular reflected light is received. Japanese Patent Laid-Open No. 2021-32887 discloses use of a plurality of ring illumination devices to obtain captured images suitable for inspection of an embossed object.

In Japanese Patent Laid-Open No. 2021-32887 described above, images need to be captured using each of the two ring illumination devices, meaning that the inspection takes time. In addition, when the inspection target region is large or a plurality of inspection target objects are inspected at a time, the inspection accuracy may be compromised due to a failure to acquire the reflected light in the vicinity of the specular reflection, unless the ring illumination devices have a large diameter.

### SUMMARY

The present disclosure provides a technique for enabling inspection of an inspection region with high accuracy in a single image capture, even when the inspection region is large or a plurality of inspection regions are inspected at a time.

According to a first aspect of the present disclosure, there is provided an inspection apparatus that comprises a plurality of light sources configured to emit light to an inspection region, an image capturing apparatus configured to capture an image of the inspection region irradiated with light from at least some of the plurality of light sources, at least one memory, and at least one processor. The at least one memory and the at least one processor are configured to perform inspection related to the inspection region based on a captured image obtained by the capturing. The plurality of light sources are arranged at positions where virtual images corresponding to the light sources surround the inspection region.

According to a second aspect of the present disclosure, there is provided a method of controlling an inspection apparatus, the method comprising: capturing an image of an inspection region irradiated with light from at least some of a plurality of light sources configured to irradiate the inspection region with light; and performing inspection related to the inspection region based on a captured image obtained by the capturing, wherein the plurality of light sources are arranged at positions where virtual images corresponding to the light sources surround the inspection region.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a hardware configuration example of an inspection apparatus.

FIG. 2 is a diagram illustrating an example of an arrangement of an image capturing apparatus 111 and a light source apparatus 116.

FIG. 3 is a block diagram illustrating a functional configuration example of the inspection apparatus.

FIG. 4A is a diagram illustrating an arrangement position of a gloss inspection light source 203-1.

FIG. 4B is a diagram illustrating an arrangement position of the gloss inspection light source 203-1.

FIG. 4C is a diagram illustrating an arrangement position of the gloss inspection light source 203-1.

FIG. 4D is a diagram illustrating an arrangement position of the gloss inspection light source 203-1.

FIG. 5 is a diagram illustrating a specific example of a first embodiment.

FIG. 6 is a flowchart of processing executed by the information processing apparatus 1, for calculating the arrangement positions of gloss inspection light sources 203-1.

FIG. 7 is a diagram illustrating an arrangement result of the gloss inspection light sources 203-1.

FIG. 8 is a flowchart of processing executed by the inspection apparatus for inspecting an inspection target.

FIG. 9 is a bird's-eye view of a sample surface as viewed from directly above an image capturing apparatus 111 arranged with four inspection targets arranged on the sample surface while being included in the angle of view.

FIG. 10 is a flowchart of processing executed by the information processing apparatus 1, for calculating the arrangement positions of the gloss inspection light sources 203-1.

FIG. 11A is a diagram illustrating a specific example of step S1006.

FIG. 11B is a diagram illustrating a specific example of step S1006.

FIG. 12 is a bird's-eye view of a configuration in which the gloss inspection light sources 203-1 are arranged at arrangement positions determined as “arrangement positions at which the gloss inspection light sources 203-1 are to be arranged” in step S1006.

FIG. 13A is a front view illustrating an arrangement example of the gloss inspection light sources and color/unevenness inspection light sources.

FIG. 13B is a diagram illustrating an arrangement example of the gloss inspection light sources.

FIG. 14 is a flowchart of processing executed by the inspection apparatus for inspecting an inspection target.

FIG. 15 is a flowchart illustrating details of processing in step S1401.

FIG. 16 is a diagram illustrating an exemplary inspection target.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

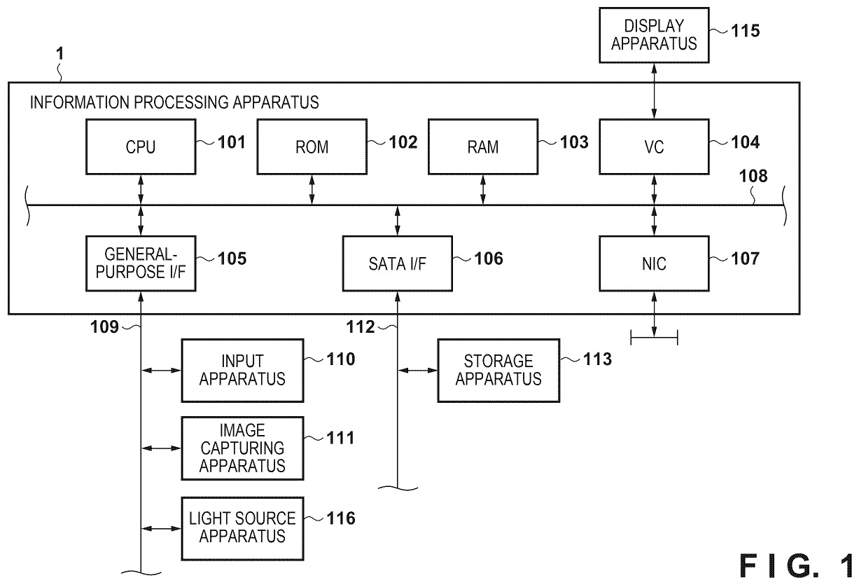

First of all, a hardware configuration example of an inspection apparatus according to the present embodiment will be described using the block diagram of FIG. 1. As illustrated in FIG. 1, the inspection apparatus according to the present embodiment includes an information processing apparatus 1, a display apparatus 115, an input apparatus 110, an image capturing apparatus 111, a light source apparatus 116, and a storage apparatus 113.

A CPU 101 executes various types of processing using computer programs and data stored in a RAM 103. Accordingly, the CPU 101 controls operation of the entire information processing apparatus 1, and also executes or controls various types of processing described to be executed by the information processing apparatus 1.

In a ROM 102, setting data of the information processing apparatus 1, a computer program and data relating to activation of the information processing apparatus 1, a computer program and data relating to a basic operation of the information processing apparatus 1, and the like are stored.

The RAM 103 includes an area for storing computer programs and data loaded from the ROM 102 or the storage apparatus 113, and an area for storing captured images output from the image capturing apparatus 111. The RAM 103 further has a work area used when the CPU 101 executes various types of processing. As such, the RAM 103 can provide various areas as appropriate.

The display apparatus 115 is connected to a video card (VC) 104. For example, the CPU 101 can cause the display apparatus 115 to display the processing result obtained by the CPU 101 in the form of an image, characters, or the like by outputting the processing result to the display apparatus 115 via the VC 104. The display apparatus 115 is a display apparatus including a liquid crystal screen and a touch panel screen. The display apparatus 115 may be a projection apparatus, such as a projector.

The input apparatus 110, the image capturing apparatus 111, and the light source apparatus 116 are connected to a general-purpose interface (I/F) 105.

The input apparatus 110, which is a user interface such as a keyboard, a mouse or a touch panel, is operable by a user to input various instructions and information to the information processing apparatus 1.

The image capturing apparatus 111 is an apparatus provided to capture images of an inspection target (object), and may be a still image capturing apparatus that captures still images regularly or irregularly or may be a moving image capturing apparatus that captures moving images. The light source apparatus 116 is an apparatus provided to irradiate the inspection target with light, and includes a plurality of light sources.

The storage apparatus 113 is connected to a serial ATA (SATA) I/F 106.

The CPU 101 reads and writes computer programs and data from and to the storage apparatus 113 via the SATA I/F 106.

The storage apparatus 113 is a large-capacity information storage apparatus such as a hard disk drive apparatus. The storage apparatus 113 has stored therein the OS, computer programs, and data for causing the CPU 101 to execute or control various types of processing described to be executed by the information processing apparatus 1, and the like.

The information processing apparatus 1 can be connected to a network such as a LAN or the Internet via a network interface card (NIC) 107, and can perform data communication with apparatuses on the network. The information processing apparatus 1 may acquire a part or all of the information used in each processing to be described below from an apparatus on a network via the NIC 107.

The CPU 101, the ROM 102, the RAM 103, the VC 104, the general-purpose I/F 105, the SATA I/F 106, and the NIC 107 are each connected to a system bus 108. A computer apparatus such as a personal computer (PC), a smartphone, and a tablet terminal apparatus is applicable as the information processing apparatus 1. Further, the configuration of the inspection apparatus illustrated in FIG. 1 is merely an example, and two or more of the apparatuses illustrated in FIG. 1 may be combined to form an apparatus.

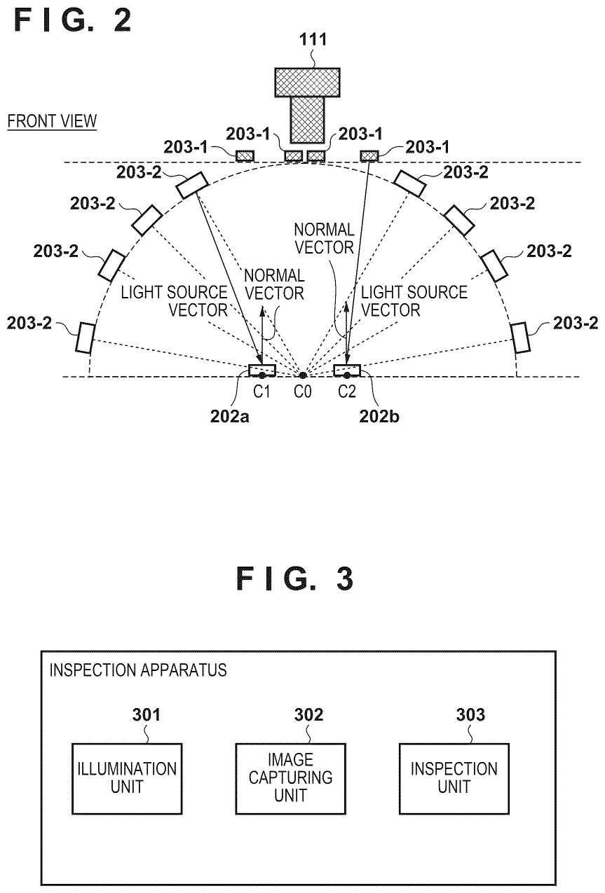

Next, an arrangement example of the image capturing apparatus 111 and the light source apparatus 116 arranged for performing gloss, color, and unevenness inspection for the inspection target will be described with reference to FIG. 2. The light source apparatus 116 includes gloss inspection light sources 203-1 that irradiate the inspection target with light in order to perform the gloss inspection for the inspection target, and color/unevenness inspection light sources 203-2 that irradiate the inspection target with light in order to perform the color and unevenness inspection for the inspection target.

In the present embodiment, as illustrated in FIG. 2, the inspection target includes two inspection targets that are an inspection target 202a and an inspection target 202b placed on a sample surface. The gloss inspection light sources 203-1 and the color/unevenness inspection light sources 203-2 are arranged so as to surround these two inspection targets, and irradiate the two inspection targets with light. The image capturing apparatus 111 simultaneously captures images of the two inspection targets irradiated with light by the gloss inspection light sources 203-1 and the color/unevenness inspection light sources 203-2 (captures images of the two inspection targets in a state in which the two inspection targets are included in the angle of view of the image capturing apparatus 111). The information processing apparatus 1 performs inspection on the gloss, the color, and the unevenness of the two inspection targets from the captured images (the captured images obtained by simultaneously capturing the images of the two inspection targets) obtained by the image capturing.

In the present embodiment, LEDs are used as the light sources in the light source apparatus 116, but the type of the light sources is not limited to a specific type, and for example, another type of light source, such as xenon lamps, may be used. In the inspection for the inspection targets using the captured images, the light irradiation method needs to be changed according to the items of the appearance inspection for the inspection targets.

For example, in a case of the inspection on the color or unevenness of the inspection targets, it is necessary to irradiate light from multiple directions which prevents light specularly reflected off of the inspection surface of the inspection target from entering. Therefore, the color/unevenness inspection light sources 203-2 are each arranged in a direction leading to a relatively large angle formed by an incident vector of light with which an inspection target is irradiated and a normal vector of the inspection target irradiation with the light (to be diffusive reflection as viewed from the image capturing apparatus 111).

Further, for example, in a case of the inspection on the gloss of the inspection target, it is necessary to irradiate the inspection surface of the inspection target with light in a direction enabling an image to be captured with reflected light in the vicinity of the specular reflection. Therefore, the gloss inspection light sources 203-1 are each arranged in a direction leading to a relatively small angle formed by an incident vector of light with which an inspection target is irradiated and a normal vector of the inspection target irradiation with the light (to be in the vicinity of the specular reflection as viewed from the image capturing apparatus 111).

Further details regarding how the gloss inspection light sources 203-1 are arranged will be described below. By combining the captured images of the inspection target irradiated with the light sources in the plurality of directions using a known photometric stereo method, it is possible to generate an inspection image including normal line information indicating unevenness and color information corresponding to reflectance. Note that the gloss inspection light sources 203-1 and the color/unevenness inspection light sources 203-2 may be different from each other in light emitting surface and spectral characteristics.

A functional configuration example of the inspection apparatus is illustrated in the block diagram of FIG. 3. An illumination unit 301 corresponds to the light source apparatus 116, and an image capturing unit 302 corresponds to the image capturing apparatus 111. An inspection unit 303 corresponds to a functional unit related to inspection for inspection objects in the information processing apparatus 1.

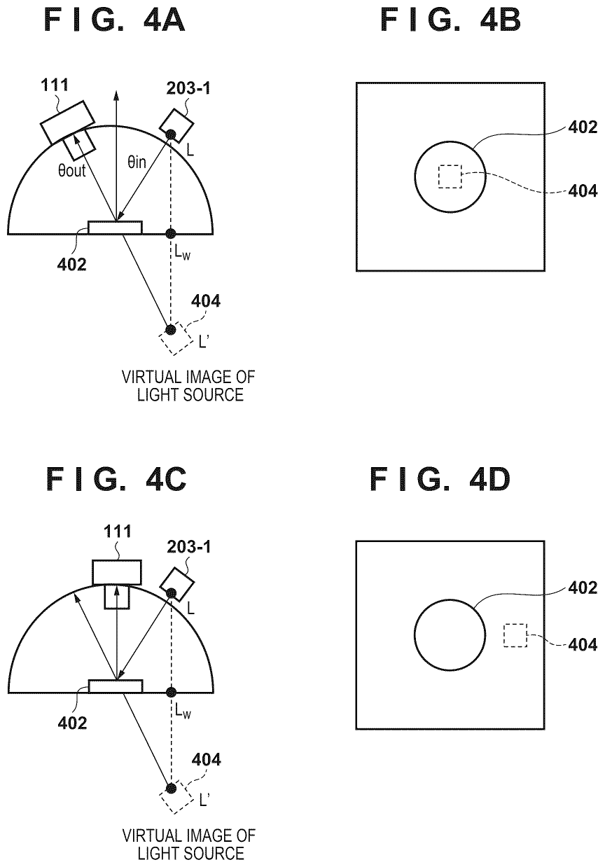

Now, the arrangement position of the gloss inspection light source 203-1 according to the present embodiment will be described with reference to FIG. 4. FIG. 4A illustrates the positional relationship among the gloss inspection light source 203-1, an inspection target 402 placed on the sample surface, and the image capturing apparatus 111 installed in the specular reflection direction among the reflected light directions in which light emitted from the gloss inspection light source 203-1 is reflected by the inspection target 402. The image capturing apparatus 111 is arranged with the center of the inspection target 402 located at the center of the angle of view, that is, in the specular reflection direction of light from the gloss inspection light source 203-1. Here, the position of a foot vertically extending from a position L of the gloss inspection light source 203-1 to the sample surface is defined as Lw.

The image capturing apparatus 111 captures a virtual image 404 corresponding to the gloss inspection light source 203-1 at a position L′ on a straight line passing through the position L and the position Lw. Here, the distance between the position Lw and the position L′ is the same as the distance between the position L and the position Lw. The virtual image is a kind of image formed by reverse-direction extensions of light rays that are refracted or reflected by a lens or a mirror but are not converged into an actual image. The light rays are characterized in that they appear to be emitted from the virtual image. An erect image formed by a lens and a mirror image formed by a plane mirror are virtual images.

In this context, the positional relationship between the inspection target 402 and the virtual image 404 as viewed from the image capturing apparatus 111 is a positional relationship in which the inspection target 402 and the virtual image 404 overlap each other as illustrated in FIG. 4B. The image captured by the image capturing apparatus 111 under such a condition corresponds to, for example, a captured image of a plane mirror placed on the sample surface, and the positional relationship between the inspection target 402 and the virtual image 404 in the captured image is the positional relationship illustrated in FIG. 4B.

The arrangement of the image capturing apparatus 111 in FIG. 4C is different from that in FIG. 4A, and the image capturing apparatus 111 is arranged immediately above the inspection target 402 with the center of the inspection target 402 located at the center of the angle of view so as to capture the neighboring light of the specular reflected light, from the inspection target 402, of the light emitted from the gloss inspection light source 203-1.

Under this condition, the inspection target 402 and the virtual image 404 are, as viewed from the image capturing apparatus 111, in a positional relationship with the position of the virtual image 404 slightly shifted from the inspection target 402 as illustrated in FIG. 4D. The image captured by the image capturing apparatus 111 under such a condition corresponds to, for example, a captured image of a plane mirror placed on the sample surface, and the positional relationship between the inspection target 402 and the virtual image 404 in the captured image is the positional relationship illustrated in FIG. 4D.

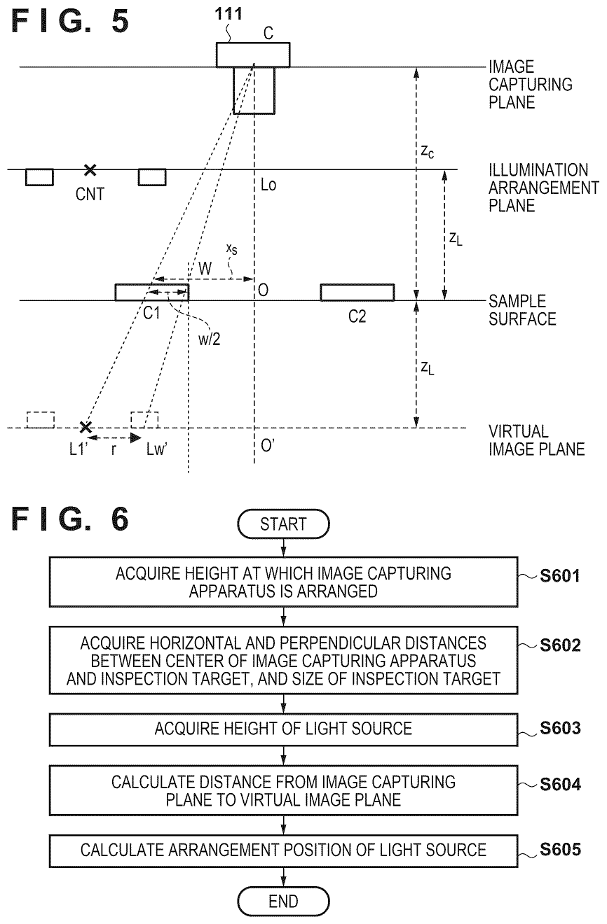

In the present embodiment, in view of these, the light sources are arranged at such arrangement positions that the virtual images of the light sources surround the inspection target as viewed from the image capturing apparatus. Processing executed by the information processing apparatus 1, for calculating the arrangement positions of the gloss inspection light sources 203-1, will be described with reference to a flowchart in FIG. 6. A specific example is described below using an example of a case where the inspection targets are placed at a position C1 and a position C2 on the sample surface, the gloss inspection light sources 203-1 are arranged on a plane (illumination arrangement plane) at a height ZL from the sample surface, and the image capturing apparatus 111 is arranged at a plane (image capturing plane) at a height ZC from the sample surface, as illustrated in FIG. 5. In the present embodiment, the gloss inspection light source 203-1 is arranged for each inspection target. While processing for calculating the arrangement position of the gloss inspection light source 203-1 for the inspection target arranged at the position C1 will be described below, similar processing is also performed for the inspection target arranged at the position C2.

In FIG. 5, a position of a foot vertically extending from a center position C of an image sensor of the image capturing apparatus 111 to the sample surface is defined as a position O, and a position of an intersection between a straight line passing through the center position C and the position O and the illumination arrangement plane is set as a position LO.

In step S601, the CPU 101 acquires the height ZC (distance between the center position C and the position O). A method by which the CPU 101 acquires the height ZC is not limited to a specific method. For example, the CPU 101 may acquire the height ZC input by a user operating the input apparatus 110, or may acquire the height ZC stored in advance in the storage apparatus 113. The height ZC can be set to a desired value by the user in accordance with the size of the inspection target, the size and fineness of a defect, or the like.

In step S602, the CPU 101 acquires a distance xs (distance between the position O and the position C1) between the center position C and the position C1 in an x-axis direction (left-right direction in the drawing sheet), a distance ys (0 in FIG. 5) between the center position C and the position C1 in a y-axis direction (direction perpendicular to the drawing sheet), and a size w (size in the x-axis direction in FIG. 5) of the inspection target. A method by which the CPU 101 acquires the distance xs, the distance ys, and the size w of the inspection target is not limited to a specific method. For example, the CPU 101 may acquire the distance xs, the distance ys, and the size w of the inspection target input by the user operating the input apparatus 110, or may acquire the distance xs, the distance ys, and the size w of the inspection target stored in advance in the storage apparatus 113. The distance xs can be set to a desired value by the user in accordance with the size of the inspection target.

In step S603, the CPU 101 acquires the height ZL (the distance between position LO and position O). A method by which the CPU 101 acquires the height ZL is not limited to a specific method. For example, the CPU 101 may acquire the height ZL input by the user operating the input apparatus 110, or may acquire the height ZL stored in advance in the storage apparatus 113. The height ZL can be set to a desired value by the user.

In step S604, the CPU 101 calculates CO′, which is the sum of the height ZC acquired in step S601 and the height ZL acquired in step S603, using the following Equation (1):

$${CO}^{′} = ZC + ZL . \qquad ( 1 )$$

A plane of the virtual image (virtual image plane) corresponding to the light source arranged on the illumination arrangement plane is a plane positioned downward from the sample surface by the distance ZL. Here, a position of an intersection between a straight line passing through the center position C and the position O and the virtual image plane is defined as a position O′. At this time, CO′ calculated using the above Equation (1) is the distance between the center position C and the position O′ (that is, the distance between the image capturing plane and the virtual image plane).

In step S605, the CPU 101 calculates the arrangement position on the illumination arrangement plane of the gloss inspection light source 203-1 that irradiates the inspection target with light. In the present embodiment, a case will be described in which N gloss inspection light sources 203-1 are annularly (at positions on a circle with the center at a center position CNT on the illumination arrangement plane and with a radius r) and isotropically arranged on the illumination arrangement plane with respect to the inspection target.

Here, an intersection position between a straight line passing through the center position C and the position C1 and the virtual image plane is defined as a position L1′. Under this condition, based on the fact that a triangle CO′L1′ and a triangle COC1 are similar to each other, the CPU 101 calculates a distance O′L1′ between the position O′ and the position L1′ as the x coordinate of the center position CNT using the following Equation (2):

$$x coordinate of center position CNT = {O}^{′} L {1}^{′} = {CO}^{′} / ZC \times xs . \qquad ( 2 )$$

Thus, the x coordinate of the center position CNT corresponds to the distance between the position LO and the x coordinate of the center position CNT. In the example of FIG. 5, the y coordinate of the center position CNT is 0. Accordingly, it is possible to calculate the position where the virtual image of the center position CNT is arranged at the center of the inspection target. Next, the CPU 101 calculates an arrangement interval 40 of the N gloss inspection light sources 203-1 using the following Equation (3):

$$Δ θ = ( 360 - θ a ) / ( N - 1 ) . \qquad ( 3 )$$

Here, θa is a value for adjusting the arrangement position of the gloss inspection light sources 203-1 so that the gloss inspection light sources 203-1 would not be included in the angle of view range of the image capturing apparatus 111, and is a value set in advance based on the installation conditions of the image capturing apparatus 111 and the like.

Here, the position of the right end of the inspection target is defined as a position W, and the position of the virtual image of the gloss inspection light source 203-1 corresponding to the right end is defined as LW′. Under this condition, based on the fact that a triangle CC1W and a triangle CLI′Lw′ are similar to each other, the CPU 101 calculates the radius r described above (the distance between the position L1′ and the position LW′) to make the virtual image arranged on the outer side of the inspection target, using the following Equation (4):

$$r = w \times ( ZL + ZC ) / ( 2 \times ZC ) . \qquad ( 4 )$$

Then, the CPU 101 calculates a position (xn,yn) of the n-th gloss inspection light source 203-1 among the N gloss inspection light sources 203-1 (1≤n≤N) using the following Equation (5):

$$( Equation 5 )$$

$$x n = ( x coordinate of center position CNT ) + cos ( θ a / 2 + ( n - 1 ) Δ θ )$$

$$yn = ( y coordinate of center position CNT ) + sin ( θ a / 2 + ( n - 1 ) Δθ ) .$$

Here, the position (xn,yn) represents the position of the n-th gloss inspection light source 203-1 on the illumination arrangement plane, with the position LO being the origin on the illumination arrangement plane, the “left-right direction on the drawing sheet” being the x-axis direction, and the “direction perpendicular to the drawing sheet” being the y-axis direction.

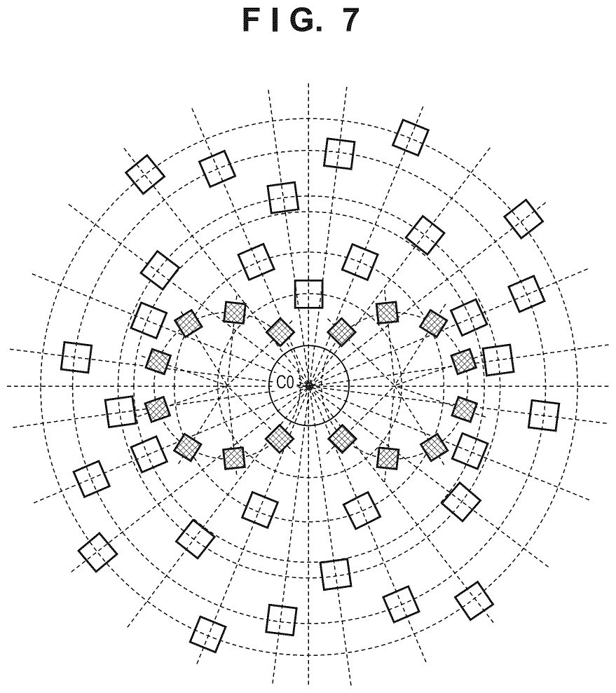

The arrangement position of the gloss inspection light source 203-1 suitable for the gloss unevenness inspection is determined by the processing according to the flowchart in FIG. 6. Thus, the user arranges the gloss inspection light source 203-1 at the arrangement position determined for the gloss inspection light source 203-1. FIG. 7 illustrates an arrangement result of the gloss inspection light sources 203-1. FIG. 7 corresponds to the top view of FIG. 2. In FIG. 7, black rectangles indicate the gloss inspection light sources 203-1, and white rectangles indicate virtual images of the gloss inspection light sources 203-1. As illustrated in FIG. 7, the gloss inspection light sources 203-1 are arranged so that the corresponding virtual images surround the inspection target as viewed from the position of the image capturing apparatus 111, and are installed to be not included in the angle of view of the image capturing apparatus 111.

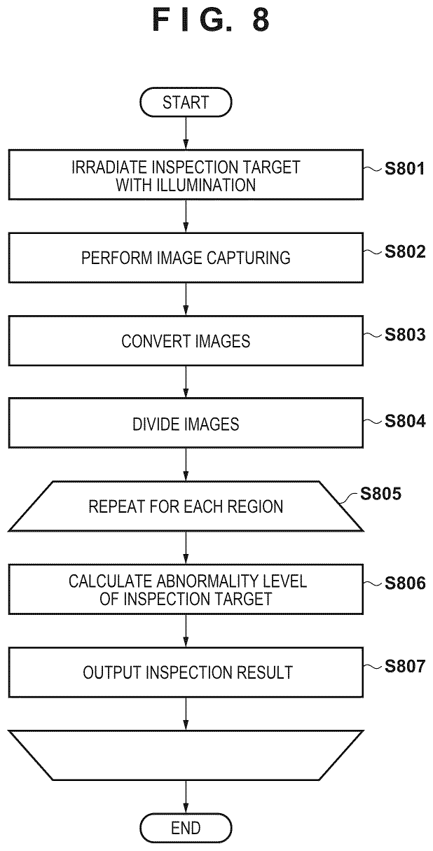

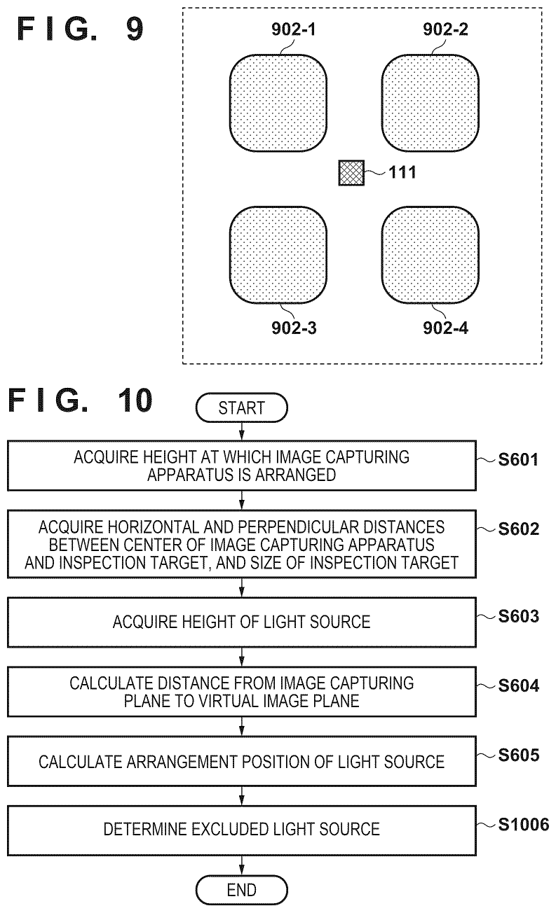

Processing executed by the inspection apparatus with the gloss inspection light source 203-1 arranged at the arrangement position calculated according to the flowchart in FIG. 6, to inspect the inspection target, will be described with reference to a flowchart in FIG. 8.

In step S801, the CPU 101 controls the light source apparatus 116 to control light emission by the gloss inspection light sources 203-1 and the color/unevenness inspection light sources 203-2. In the present embodiment, the gloss inspection light sources 203-1 are turned ON at once, that is, not individually, whereas the color/unevenness inspection light sources 203-2 are turned ON one by one, that is, individually.

In step S802, the CPU 101 controls the image capturing apparatus 111 to capture images of the inspection targets in synchronization with the turn-ON timing of the light sources (the gloss inspection light sources 203-1 and the color/unevenness inspection light sources 203-2).

In step S803, the CPU 101 acquires a plurality of captured images of the inspection targets captured by the image capturing apparatus 111 via the general-purpose I/F 105. Then, the CPU 101 converts each of the plurality of captured images thus acquired, to acquire RGB images. In the present embodiment, the captured images are images (HEIF images) of High Efficiency Image File Format (HEIF). In this case, the CPU 101 decodes the HEIF images using a decoding method of known HEIF format. The format of the captured images is not limited to HEIF format. For example, the captured images may be images in JPEG format or another compression format. Then, the CPU 101 executes de-gamma processing on the RGB images obtained by the decoding to convert the RGB images into RGB images exhibiting a linear relationship with the brightness value. The RGB images obtained by the conversion may be converted into predetermined RGB images, such as sRGB images, by using a conversion table based on the characteristics of the image capturing apparatus 111.

In step S804, the CPU 101 divides each of the RGB images obtained by the processing in step S803 into divided images, the number of which is the same as the number of the inspection targets whose images are captured. In the present embodiment, since the number of inspection targets whose images are to be captured at a time is two, each RGB image is divided into a left-half divided image and a right-half divided image. How the RGB images are divided is not limited to a specific division method. For example, the inspection targets may be extracted from the RGB images, and the RGB images may be divided based on the extraction result.

In step S805, the CPU 101 repeats the processing in step S806 for each of the divided images acquired in step S804 in the order of inspection. In step S806, the CPU 101 selects one unselected divided image from among all the divided images, as a selected divided image. Then, the CPU 101 executes inspection processing on the inspection target using the selected divided image. In the present embodiment, the inspection processing is executed for three types of appearance inspection items, which are color, shape, and gloss. The items for the appearance inspection are not limited to these. It is possible to use anything indicative of the appearance and determinable through image capturing, such as, material or pattern, for example. In the present embodiment, a defect is detected by executing spatial filter processing on captured images or inspection images including normal line information and color information synthesized by the photometric stereo method. In the present embodiment, the CPU 101 calculates, as an abnormality level, a value obtained by digitizing, through integration, a reaction value corresponding to the spatial filter processing on the inspection image.

In step S807, the CPU 101 compares the abnormality level calculated in step S806 with a threshold. The CPU 101 determines that there is abnormality (the inspection result is “fail”) when the abnormality level is equal to or more than the threshold, and determines that there is no abnormality (the inspection result is “pass”) when the abnormality level is less than the threshold. Then, the CPU 101 displays an image or a character indicating the determination result on the display apparatus 115. Note that output of the determination result is not limited to displaying on the display apparatus 115, and various methods may be employed.

As described above, in the present embodiment, the light sources are arranged such that the virtual images of the light sources (as viewed from the position of the image capturing apparatus) on the surface on which the inspection target is placed surround the inspection target as viewed from the position of the image capturing apparatus. Then, the image capturing for the inspection target is performed in synchronization with the turning ON of the light sources, and inspection processing is sequentially executed. Thus, the defect detection for the inspection target can be performed with high accuracy.

While the case where the information processing apparatus 1 executes the processing in the flowchart of FIG. 6 is described in the present embodiment, it is not limited thereto, and another computer apparatus not included in the inspection apparatus may execute the processing in the flowchart in FIG. 6.

### Variation Example

In the first embodiment, the number of light sources to be arranged is set in advance, and the arrangement positions of the light sources are determined using the constant θa set in advance to prevent the light sources from being included in the angle of view range of the image capturing apparatus 111 as in Equation (3). However, a method for preventing the light sources from being included in the angle of view range of the image capturing apparatus 111 is not limited to such a method. For example, when the number of light sources to be arranged is not designated in advance, the arrangement positions of the N light sources are calculated using Equations (1) to (5) without using the constant θa (θa=0). Then, the light sources may be arranged at arrangement positions to be not included in the angle of view range of the image capturing apparatus 111 among the calculated arrangement positions.

### Second Embodiment

In each of the following embodiments and variation examples including the present embodiment, only the difference from the first embodiment will be described, assuming that they are similar to the first embodiment unless otherwise stated. In the first embodiment, a case is described where two inspection targets are inspected using captured images obtained by simultaneously capturing images of the two inspection targets. However, the number of inspection targets is not limited to two. In the present embodiment, a case will be described in which four inspection targets are inspected using captured images obtained by simultaneously capturing images of the four inspection targets.

FIG. 9 is a bird's-eye view of a sample surface as viewed from directly above the image capturing apparatus 111 arranged with four inspection targets (inspection targets 902-1, 902-2, 902-3, and 902-4) arranged on the sample surface while being included in the angle of view. In the following description, as illustrated in FIG. 9, the arrangement positions of the inspection targets 902-1, 902-2, 902-3, and 902-4 on the sample surface are assumed to be C1, C2, C3, and C4, respectively.

Processing executed by the information processing apparatus 1, for calculating the arrangement positions of the gloss inspection light sources 203-1, will be described with reference to a flowchart in FIG. 10. In FIG. 10, processing steps similar to the processing steps illustrated in the flowchart in FIG. 6 are provided with the same step numbers as the processing steps in FIG. 6, and description of these processing steps in FIG. 10 is omitted. Also in the present embodiment, the processing in steps S601 to S605 is executed for each inspection target.

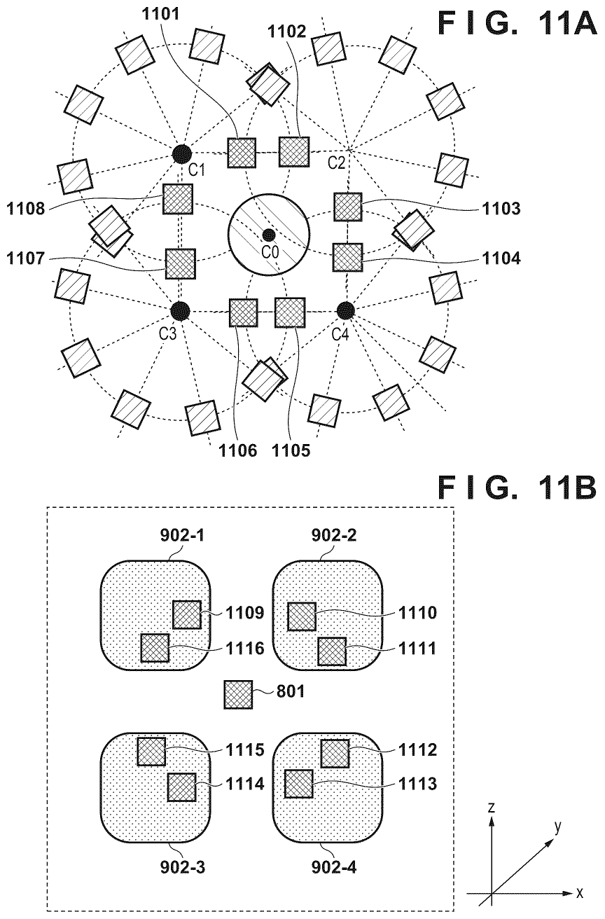

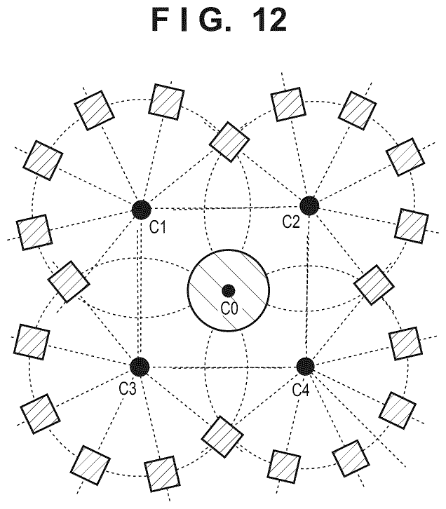

In step S1006, the CPU 101 determines arrangement positions at which the gloss inspection light sources 203-1 would not be arranged, among the arrangement positions calculated in step S605. The processing in step S1006 will be described with reference to a specific example in FIG. 11. In FIG. 11A, rectangles arranged on the circumference around the position C1 as the center, rectangles arranged on the circumference around the position C2 as the center, rectangles arranged on the circumference around the position C3 as the center, and rectangles arranged on the circumference around the position C4 as the center all indicate the arrangement positions of the gloss inspection light sources 203-1 calculated in step S605.

An arrangement position 1101 of the gloss inspection light source 203-1 corresponds to one of the light sources in the vicinity of the specular reflection of the inspection target 902-2. Meanwhile, a position 1109 of the virtual image corresponding to the gloss inspection light source 203-1 at the arrangement position 1101 overlaps the inspection target 902-1, and thus corresponds to a light source that causes specular reflection of another inspection target.

Similarly, an arrangement position 1103 of the gloss inspection light source 203-1 corresponds to a light source in the vicinity of specular reflection with respect to the inspection target 902-4. Meanwhile, a position 1111 of the virtual image corresponding to the gloss inspection light source 203-1 at the arrangement position 1103 overlaps the inspection target 902-2, and thus corresponds to a light source that causes specular reflection of another inspection target.

As described above, among the arrangement positions of the gloss inspection light sources 203-1 illustrated in FIG. 11A, the positions 1101 to 1108 correspond to light sources that cause specular reflection of another inspection target, and are not light sources suitable for inspection for the inspection target. Therefore, in the case of FIG. 11, in step S1006, the CPU 101 determines the positions 1101 to 1108 among the arrangement positions calculated in step S605 as the positions where the gloss inspection light sources 203-1 are not to be arranged.

More specifically, the CPU 101 determines whether the position of the virtual image corresponding to the arrangement position calculated in step S605 overlaps the inspection target. As described in the first embodiment, such determination processing can be executed using the various parameters (the position of the image capturing apparatus 111, the position of the inspection target, ZL, ZC, W, and the like) illustrated in FIG. 5. Upon determining that there is an overlap as a result of the determination processing, the CPU 101 determines the arrangement position as the “arrangement positions at which the gloss inspection light sources 203-1 would not be arranged”. On the other hand, upon determining that there is no overlap as a result of the determination processing, the CPU 101 determines the arrangement position as the “arrangement positions at which the gloss inspection light sources 203-1 are to be arranged”. The CPU 101 executes such processing for each of the arrangement positions calculated in step S605.

FIG. 12 is a bird's-eye view of a configuration in which the gloss inspection light sources 203-1 are arranged at the arrangement positions determined as the “arrangement positions at which the gloss inspection light sources 203-1 are to be arranged” in step S1006. As illustrated in FIG. 12, the light sources are arranged so that the virtual images surround each inspection target, and the light sources causing specular reflection with respect to other inspection targets are removed.

As described above, in the present embodiment, even when the number of inspection targets is three or more, the light sources can be arranged such that the virtual images of the light sources surround each of the plurality of inspection targets, and no light sources causing specular reflection with respect to other inspection targets are arranged. Thus, even when the number of inspection targets is larger than two, inspection for the inspection targets can be performed with high accuracy.

### Variation Example

While the case where the number of inspection targets is four is described in the second embodiment, which is not limiting, for example, in a case where a plurality of inspection regions are set for one inspection target, the light sources can be arranged so as to surround the virtual images of the light sources for each inspection region. The same goes for the first embodiment. That is, in the above description, the inspection target may be regarded as “one inspection region set as the inspection target” or “each inspection region set as the inspection target”.

### Third Embodiment

In the first embodiment and the second embodiment, the case is described where the arrangement positions of the light sources suitable for the inspection target (inspection region) are calculated in advance, the light sources are arranged at the arrangement positions, and light is emitted from each of the arranged light sources. In the present embodiment, a case will be described where the light sources that emit light are dynamically determined in accordance with the shape of the inspection region.

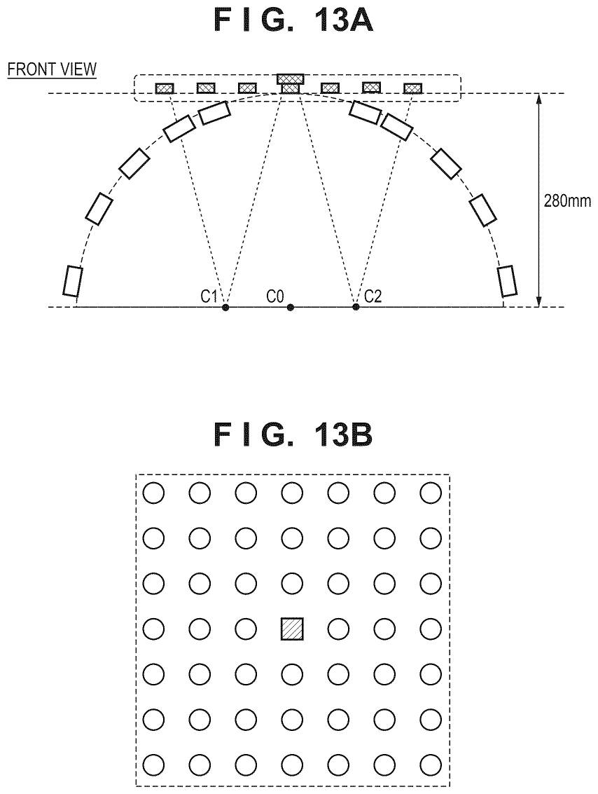

FIG. 13A is a front view illustrating an arrangement example of gloss inspection light sources and the color/unevenness inspection light sources. In FIG. 13A, black rectangles indicate gloss inspection light sources, which are arranged on a surface at a predetermined height (280 mm in FIG. 13A) from the sample surface. White rectangles indicate color/unevenness inspection light sources, and are arranged so as to surround the positions C1, C2, and C3 of the inspection targets on the sample surface. The gloss inspection light sources are arranged in a matrix as illustrated in FIG. 13B (no gloss inspection light source is arranged in the black rectangle at the center), and a group of gloss inspection light sources are installed with the plane formed by the group of gloss inspection light sources being substantially parallel to the sample surface.

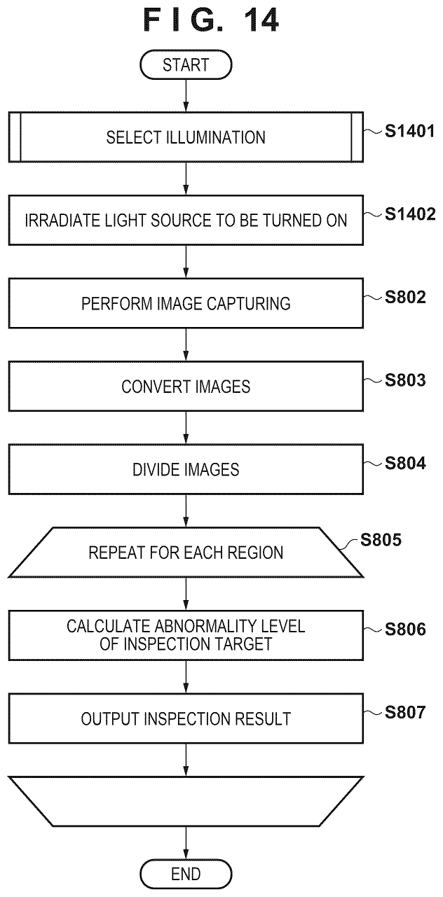

Processing executed by the inspection apparatus for inspection for an inspection target will be described with reference to a flowchart in FIG. 14. In FIG. 14, processing steps similar to the processing steps illustrated in FIG. 8 are denoted by the same step numerals as the processing steps in FIG. 8, and description of these processing steps in FIG. 14 is omitted.

In step S1401, the CPU 101 selects the gloss inspection light sources 203-1 to emit light (to be turned ON) among the gloss inspection light sources 203-1. Details of the processing in step S1401 will be described later.

In step S1402, the CPU 101 controls the light source apparatus 116 to control light emission by the gloss inspection light sources 203-1 (the gloss inspection light sources 203-1 selected in step S1401) and the color/unevenness inspection light sources 203-2.

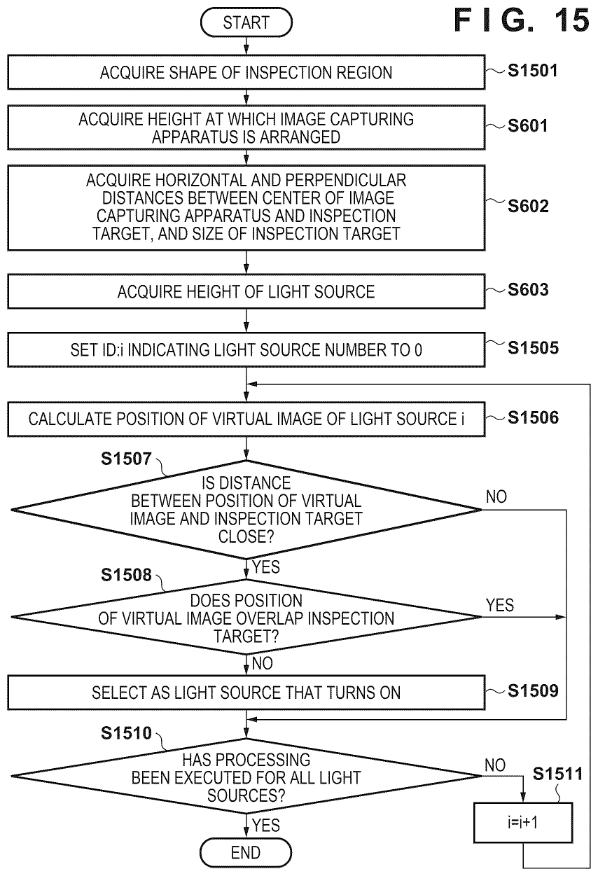

The processing in step S1401 will be described next in detail with reference to the flowchart in FIG. 15. In FIG. 15, processing steps similar to the processing steps illustrated in FIG. 6 are denoted by the same step numerals as the processing steps in FIG. 6, and description of these processing steps in FIG. 15 is omitted.

In step S1501, the CPU 101 acquires shape information, which is information indicating the shape of an inspection region on an inspection surface. For example, the shape information has a flag value corresponding to each position on the sample surface, and the flag value is “1” if the position is within the inspection region and is “0” if the position is outside the inspection region.

A method by which the CPU 101 acquires the shape information is not limited to a specific method. For example, the CPU 101 may cause the display apparatus 115 to display a group of shape information stored in advance in the storage apparatus 113 in a list, and acquire shape information selected by the user operating the input apparatus 110 from the group of shape information displayed in the list.

In step S1505, the CPU 101 initializes the value of a variable i indicating the light source number to 0. In the present embodiment, it is assumed that a unique light source number is assigned to each of the arranged gloss inspection light sources 203-1.

In step S1506, the CPU 101 performs the method (step S605) described in the first embodiment to calculate the position of the virtual image corresponding to the gloss inspection light source 203-1 with the light source number corresponding to the value of the variable i.

In step S1507, the CPU 101 determines the distance between the position of the virtual image calculated in step S1506 and the position of the inspection region indicated by the shape information. For example, the coordinates of the upper left end portion of a region (i.e., inspection region) that is a set of positions with the flag value “1” in the shape information are defined as (xupleft, yupleft), the coordinates of the lower right end portion are defined as (xdownright, ydownright), and the position of the virtual image calculated in step S1506 is defined as (xi, yi).

Under these conditions, the CPU 101 determines that “the position of the virtual image and the position of the inspection region are close to each other” when the following Equation (6) holds, and determines that “the position of the virtual image and the position of the inspection region are not close to each other” when the following Equation (6) does not hold.

$${( xi - xdownright )}^{2} + {( yi - ydownright )}^{2} < ε , \qquad ( 6 )$$

$${( xi - xupleft )}^{2} + {( yi - yupleft )}^{2} < ε .$$

Here, & is a threshold set in advance. The processing proceeds to step S1508 when the result of the determination in step S1507 is “the position of the virtual image and the position of the inspection region are close to each other”, and proceeds to step S1510 when the result is “the position of the virtual image and the position of the inspection region are not close to each other”.

In step S1508, the CPU 101 determines whether the position of the virtual image calculated in step S1506 overlaps the inspection region indicated by the shape information using the following Equation (7):

$$xupleft < xi < xdownright and yupleft < yi < ydownright . \qquad ( 7 )$$

When Equation (7) holds, it is determined that the position of the virtual image calculated in step S1506 overlaps the inspection region indicated by the shape information, and the processing proceeds to step S1510. On the other hand, when Equation (7) does not hold, it is determined that the position of the virtual image calculated in step S1506 does not overlap the inspection region indicated by the shape information, and the processing proceeds to step S1509.

In step S1509, the CPU 101 selects the gloss inspection light source 203-1 with the light source number corresponding to the value of the variable i as the “gloss inspection light source 203-1 that emits light (to be turned ON)”.

In step S1510, the CPU 101 determines whether the value of the variable i is (N−1), that is, whether the processing in step S1506 and the subsequent steps has been executed for all the gloss inspection light sources 203-1.

When a result of this determination indicates that the value of the variable i is (N−1), that is, when the processing in step S1506 and the subsequent steps has been executed for all the gloss inspection light sources 203-1, the processing proceeds to step S1402.

On the other hand, when the value of the variable i is not (N−1), that is, when there is still the gloss inspection light source 203-1 that has not yet been subjected to the processing in step S1506 and the subsequent steps, the processing proceeds to step S1511. In step S1511, the CPU 101 increments the value of the variable i by one. Then, the processing proceeds to step S1506. As described above, in the present embodiment, appropriate light sources can be dynamically selected and caused to emit light in accordance with the shape of the inspection region, and the inspection can be performed with high accuracy.

### Fourth Embodiment

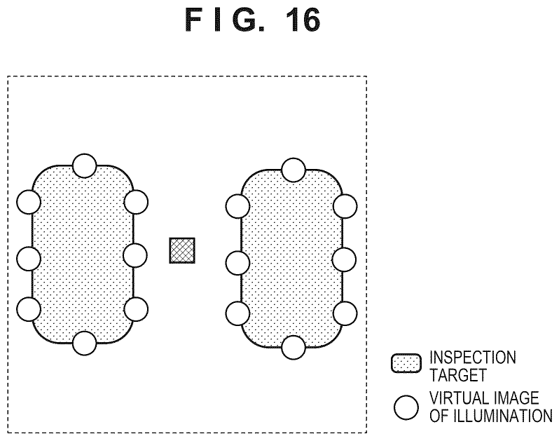

In the aforementioned embodiments and variation examples, the annular illumination is used assuming that the inspection target is a circle. However, the inspection target does not need to be a circle and is not limited to using annular illuminations. For example, the inspection target may have a square shape as illustrated in FIG. 16. In this case, the light sources may be arranged so that the virtual images corresponding to the light sources surround each inspection target. Further, the inspection target may have a shape different from a circle or a square. In this case, the light sources may be arranged to correspond to each inspection target.

Numerical values, processing timing, order of processing, entity of processing, and configuration/acquisition method/transmission destination/transmission source/storage location of data (information) or the like, used in the aforementioned embodiments and variation examples are given as an example for providing specific description, and not intended to limit to such an example.

In addition, a part or all of the aforementioned embodiments and variation examples may be used in combination as appropriate. Alternatively, some or all of the embodiments described above may be selectively used.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-096266, which was filed on Jun. 13, 2024 and which is hereby incorporated by reference herein in its entirety.

What is claimed is:

1. An inspection apparatus comprising:
a plurality of light sources configured to emit light to an inspection region;
an image capturing apparatus configured to capture an image of the inspection region irradiated with light from at least some of the plurality of light sources;
at least one memory; and
at least one processor,
wherein the at least one memory and the at least one processor are configured to perform inspection related to the inspection region based on a captured image obtained by the capturing, wherein
the plurality of light sources are arranged at positions where virtual images corresponding to the light sources surround the inspection region.

2. The inspection apparatus according to claim 1, wherein the plurality of light sources are arranged on a circle defined by a position based on a distance between the image capturing apparatus and the virtual images, a height of the image capturing apparatus, and a position of the inspection region, and by a radius based on a height of the light sources, the height of the image capturing apparatus, and a size of the inspection region.

3. The inspection apparatus according to claim 1, wherein the plurality of light sources are arranged so as not to be included in an angle of view range of the image capturing apparatus.

4. The inspection apparatus according to claim 1, wherein for each inspection region, the plurality of light sources are arranged at positions where virtual images corresponding to the light sources surround the inspection region.

5. The inspection apparatus according to claim 1, wherein
the image capturing apparatus captures images of a plurality of inspection regions irradiated with light from at least some of the plurality of light sources, with the inspection regions included in an angle of view range, and
the at least one memory and the at least one processor perform the inspection on the inspection regions based on the captured images including the plurality of inspection regions obtained by the capturing of the images.

6. The inspection apparatus according to claim 1, wherein for each inspection region, the plurality of light sources are arranged at positions where virtual images corresponding to the light sources surround the inspection region, without the virtual images being specular reflection with respect to another inspection region other than the inspection regions.

7. The inspection apparatus according to claim 1, wherein the at least one memory and the at least one processor are further configured to select, from the plurality of light sources, a light source corresponding to a virtual image that does not overlap the inspection region, as a light source that emits light based on information indicating a shape of the inspection region.

8. The inspection apparatus according to claim 1, wherein the inspection includes inspection on gloss, color, and unevenness of the inspection region.

9. The inspection apparatus according to claim 1, wherein the plurality of light sources are arranged with virtual images, corresponding to the light sources, surrounding the inspection region as viewed in a direction perpendicular to the inspection region.

10. A method of controlling an inspection apparatus, the method comprising:
capturing an image of an inspection region irradiated with light from at least some of a plurality of light sources configured to irradiate the inspection region with light; and
performing inspection related to the inspection region based on a captured image obtained by the capturing, wherein
the plurality of light sources are arranged at positions where virtual images corresponding to the light sources surround the inspection region.
